(19) United States
(12) Patent Application Publication
(10) Pub. No.: US 2024/0135140 A1
(43) Pub. Date: Apr. 25, 2024

(54) SYSTEM, DEVICES AND/OR PROCESSES FOR EXECUTING A NEURAL NETWORK ARCHITECTURE SEARCH

(71) Applicant: Arm Limited, Cambridge (GB)

(72) Inventor: Gerti Tuzi, Austin, TX (US)

(21) Appl. No.: 17/938,583

(22) Filed: Oct. 6, 2022

(51) Int. Cl. G06N 3/04

(52) U.S. Cl. CPC G06N 3/04

(57) ABSTRACT

Example methods, apparatuses, and/or articles of manufacture are disclosed that may be implemented, in whole or in part, using one or more computing devices to update parameters of an estimator to estimate and/or predict an execution latency of a neural network in a neural network architecture search (NAS) process.

### BACKGROUND

### 1. Field

The present disclosure relates generally to computer generation of designs for neural network processing devices.

### 2. Information

Neural Networks have become a fundamental building block in machine-learning and/or artificial intelligence systems. A neural network may be constructed according to multiple different design parameters such as, for example, quantization, operator type, network depth, layer width, weight bit width, approaches to pruning, just to provide a few example design parameters that may affect the behavior of a particular neural network processing architecture. Particular design choices for such design parameters may be selected based, at least in part, on particular performance and/or cost objectives.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1A is a schematic diagram of a neural network formed in “layers”, according to an embodiment;

FIG. 1B is a schematic diagram illustrating evolution of a neural network architecture search (NAS) process, according to an embodiment;

FIG. 2 is a schematic diagram illustrating an evolution of a NAS process in which a latency of an neural network architecture is estimated, according to an embodiment;

FIG. 3 is a schematic diagram illustrating an evolution of a NAS process in which a latency estimator is trained using machine learning operations, according to an embodiment;

FIG. 4 is a schematic diagram illustrating evolution of a NAS process in which a latency estimator is trained using machine learning operations including a look-ahead sampling, according to an embodiment;

FIG. 5 is a schematic diagram of a system including a NAS agent, according to an embodiment;

FIG. 6 is a flow diagram of a process to execute a NAS, according to an embodiment; and

FIG. 7 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

According to an embodiment, a neural network may comprise a graph comprising nodes to model neurons in a brain. In this context, a “neural network” as referred to herein means an architecture of a processing device defined and/or expressible by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (Al) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory (e.g., weight with negative value). In an example implementation, a neuron may apply a neural network weight to input signals, and sum weighted input signals to generate a linear combination.

According to an embodiment, edges in a neural network connecting nodes may model synapses capable of transmitting signals (e.g., represented by real number values) between neurons. Responsive to receipt of such a signal, a node/neuron may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

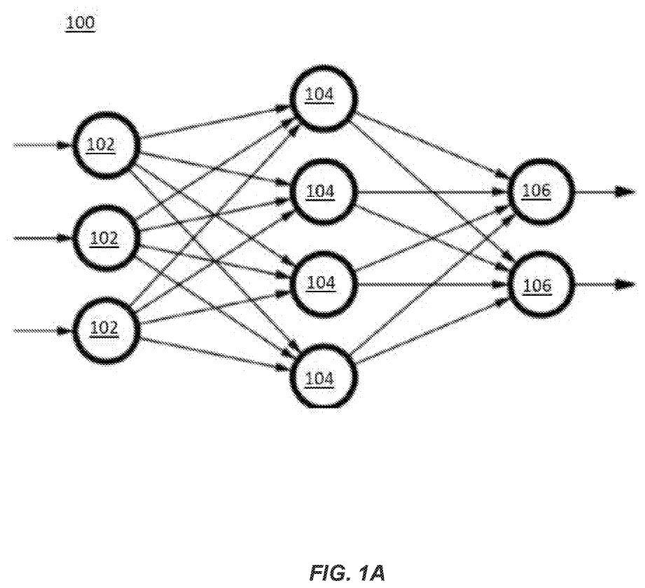

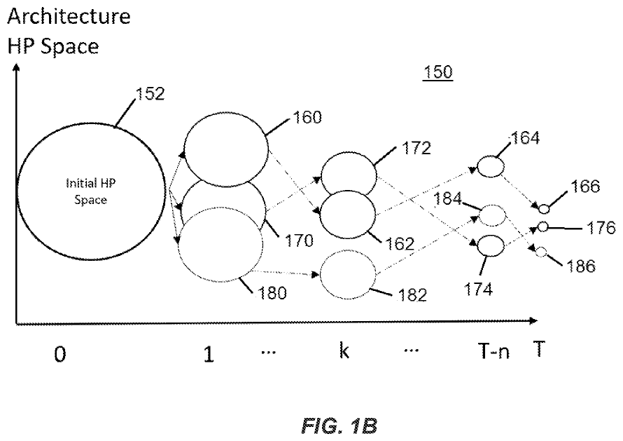

FIG. 1A is a schematic diagram of a neural network 100 formed in “layers” in which an initial layer is formed by nodes 102 and a final layer is formed by nodes 106. Neural network (NN) 100 also includes an intermediate layer formed by nodes 104. Edges shown between nodes 102 and 104 illustrate signal flow from an initial layer to an intermediate layer. Likewise, edges shown between nodes 104 and 106 illustrate signal flow from an intermediate layer to a final layer. While neural network 100 shows a single intermediate layer formed by nodes 104, it should be understood that other implementations of a neural network may include multiple intermediate layers formed between an initial layer and a final layer.

According to an embodiment, a node 102, 104 and/or 106 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node and/or edge of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect. Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples. Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ back propagation techniques to iteratively update neural network weights to be associated with nodes and/or edges of a neural network based, at least in part on “training sets.” Such training sets may include training measurements and/or observations to be supplied as input values that are paired with “ground truth” observations. Based on a comparison of such ground truth observations and associated prediction values generated based on such input values in a training process, weights may be updated according to a loss function using backpropagation.

As pointed out above, a design of a neural network may be optimized for a

particular performance and/or cost objective based, at least, in part on selection of options for decisions of particular design parameters such as, for example, network depth, layer width, operation selection, weight quantization and approaches to pruning. In one embodiment, such selected options for design parameters may be defined solely by a human design for a particular purpose. Alternatively, such choices for design parameters may be determined in an automated fashion.

According to an embodiment, design of an efficient and effective neural network architecture may entail substantial human effort and time to develop. Through experimentation, human experts have devised several useful neural network structures such as, for example, attention and residual connection. Given the virtually infinite possible design choices of a neural network architecture, however, manual search for optimal computing architectures may become unfeasible. In another embodiment, an automated neural architecture search (NAS) may enable a more rapid approach to arrive at a neural network architecture that approaches optimality.

In particular implementations, a NAS approach may apply an evolutionary algorithm (EA) and/or reinforcement learning (RL) to design neural network architectures automatically. In both RL-based and EA-based approaches, searching procedures may entail validation of accuracy of numerous architecture candidates, which may be computationally expensive. For example, an RL-based method may utilize validation accuracy as a reward to optimize an architecture generator. An EA-based method may leverage validation accuracy to decide whether a model is to be removed from a population of models. In particular implementations, these approaches may employ use of a large amount of computational resources, which may be inefficient and cost prohibitive.

According to an embodiment, design parameters affecting performance of a neural network may include, for example, layer width/number of channels, weight quantization (e.g., bit width), activation quantization (e.g., bit width), operator type, network connectivity, network depth, weight sparsity level and/or activation resolution. It should be understood, however, that these are merely examples of design parameters that may affect performance of a neural network, and that claimed subject matter is not limited in this respect.

According to an embodiment, particular NAS approaches for determining parameters of a computing device to implement a neural network (NN) based inference engine may select from among multiple available design options for a processing architecture. Such available design option may be defined by and/or limited to available computing options for implementing such a computing device.

While some techniques may define such available design options by application of a set heuristics and/or rules using a manual approach, such techniques may be limited in providing particular options capable of achieving available optimality given a target hardware and/or other constraints.

Briefly, particular implementations are directed to a method comprising: executing a neural network architecture search (NAS) process to identify candidate neural network (NN) architectures on iterations, executing the NAS process comprising computing a loss function for at least some of the NN architectures based, at least in part on a latency estimator; and updating parameters of the latency estimator on at least some iterations of the NAS process based, at least in part, on empirically determined latencies of at least some candidate NN architectures identified on the at least some iterations of the NAS process. It should be understood, however, that this is merely an example implementation and that claimed subject matter is not limited in this respect.

A NAS process may select a particular neural network architecture from among multiple network architectures in a “search space” configurable from a set of computing resources. According to an embodiment, a search space may be defined for a particular predefined neural network structure such as a CNN, Transformer neural network, a neural network of a particular number of layers, just to provide a few examples of particular predefined neural network structures for which a search space may define multiple network architectures. For such a particular predefined neural network structure, a search space may characterize and/or define multiple different instances of the particular predefined neural network structure. Such different instances of the particular predefined neural network structure may be differentiated in a search space by associated permutations of available design choices for features such as, for example, activation quantization, weight quantization, channel width for particular layers, operator selection for activation functions or search depth, just to provide a few examples of design choices that may be decisions for features of a particular predefined neural network structure. In one particular example implementation, a “search space” may be represented as a graph (e.g., stored as signals and/or states in a storage device) that is searchable in an automated NAS process.

In particular implementations, a process to select from among available candidate options for a decision regarding a feature of a neural network processing architecture may be guided, at least in part, by a computed loss function, such as a loss function L(W,Θ) according to expression (1) as follows:

L(W, Θ)=f[L_{fun}(W, Θ), Lₗₐₜ(W, Θ)] (1)

where:
W is a set of selectable weights to be associated with nodes in the neural network processing architecture;
Θ is a state parameter based on and/or expressing a design space of candidate neural networks;
L_{fun}(W, Θ) is a loss function based on functionality of the neural network processing architecture (e.g., prediction accuracy); and
Lₗₐₜ(W, Θ) is a loss function based on execution latency.

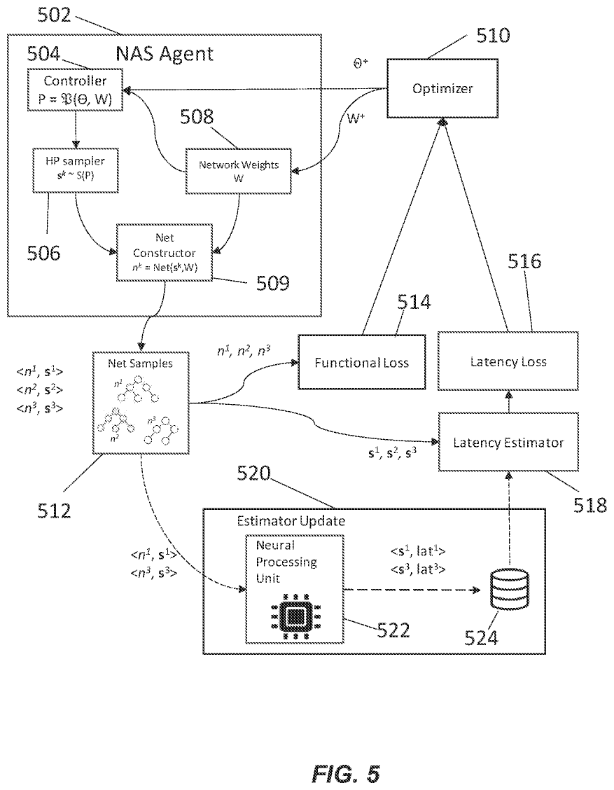

According to an embodiment, a NAS process may traverse a search space over multiple iterations to select and/or determine a neural network architecture. Such traversal of a search space may be guided, at least in part, by application of a gradient computed based on a loss function, such as a loss function computed according to expression (1). FIG. 1B is a schematic diagram illustrating evolutions of a neural network architecture search (NAS) process 150 based on an initial hyper-parameter space 152 over T iterations, according to an embodiment. Such an initial hyper-parameter search space may be defined, at least in part, based on available features of a neural network architecture such as, for example, weight quantization, activation quantization, channel width, operator types or random pruning, just to provide a few examples of parameters over which a hyperparameter search space may be defined. In iterations of NAS process 150, neural network architectures may be constructed by the selection of particular hyper parameter instances (e.g., instances of a neural network topology selected at block 506 (FIG. 5) from a search space s in expression (3)). In an initial iteration of NAS process 150, selected concentrations of sampled hyperparameter instances 160, 170 and 180 (e.g., concentration of sampled hyperparameter instances to be processed at block 520) may depend on associated seeds from a pseudo-random number generator implementation. Sampled hyperparameter instances 162, 172 and 182 (traversed from associated sampled hyperparameter instances 160, 170 and 180 in a previous iteration) may define smaller concentrations of sampled hyperparameter instances, such as respective subsets of samples in hyperparameter instances 160, 170 and 180. In a particular example, sampled hyperparameter instance 160 may specify possible channel sizes (e.g., channels for a NN layer) as {22, 44, 88, 99} while sampled hyperparameter instance 162 may represent a winnowing of this set of possible channel sizes to {44, 99}, for example.

According to an embodiment, a trajectory at instantiation of NAS process 150 may not be known a-priori and different trajectories of randomly seeded, and different NAS trajectories may partially overlap due at least in part to randomness of NAS process 150. Selected search spaces 160, 170 and 180 may then propagate to selections 162, 172 and 182, respectively, at iteration k. Similarly, selected search spaces 162, 172 and 182 may then propagate to selected search spaces 164, 174 and 184, respectively, at iteration T-n. Selected search spaces 164, 174 and 184 may then propagate to final selections 166, 176 and 186, respectively, at iteration T. As may be observed, an HP search space in earlier iterations of NAS process 150 may enable exploration of larger concentrations of sampled hyperparameter instances while NAS process 150 may more narrowly search specific neural network architectures more greedily in later iterations to arrive at optimal solutions at final selections 166, 176 and 186.

As pointed out above, a trajectory in NAS process 150 may be at least in part guided by application of a gradient to a loss function such as a loss function according to expression (1). On an iteration of NAS process 150, for example, a gradient of such a loss function may be computed to guide NAS process 150 to define selections for subsequent iterations. According to an embodiment, an estimator of a latency component of a loss function Lₗₐₜ(W, Θ) at an iteration may be determined based, at least in part, on empirically determined actual latencies for one or more similar candidate neural network architectures. Determinations of actual latency for every candidate neural network architecture at each iteration of a NAS process, however, may be computationally burdensome.

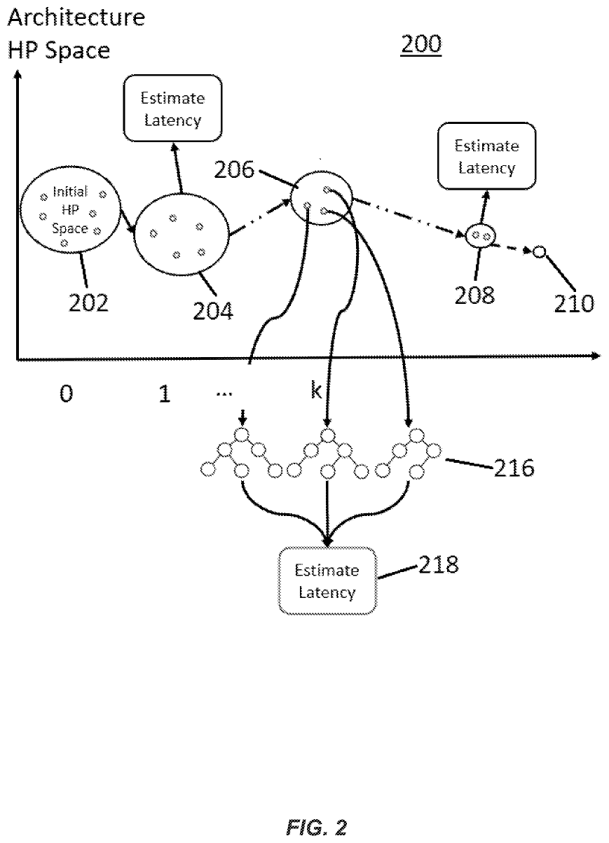

As shown in FIG. 2, according to an embodiment, a gradient of a loss function in NAS process 200 may be computed based, at least in part, on an estimated latency 218 in lieu of an empirically measured/determined actual latency. At iteration k defining three candidate neural network architectures 216, for example, associated estimated latencies 218 may be computed based, at least in part, on latencies under certain assumptions.

Here, a latency estimator may compute latency estimates from randomly selected samples from an HP space, empirically determine/measure associated latencies of the selected samples executed on neural network processing hardware, and apply the empirically determined and/or measured latencies to fit the latency estimator. There are, however, challenges to this approach. For example, with a very large HP space, a number of candidate network architectures may be correspondingly large. It may therefore be extremely resource intensive to generate an adequate representative sample set from such large HP spaces to train a reliable latency estimator. Additionally, neural network architectures from different configurations vary greatly in architectural features (depths, widths, kernels sizes, activations, etc.), and their corresponding latencies. This may necessitate a large capacity estimator to fit a correspondingly large searchable latency space. It should also be noted that a NAS process may greedily exploit interpolation errors in latency estimation. As pointed out above, a NAS process may seek to maximize functional performance (e.g., accuracy) while endeavoring low latency, which may be competing objectives. For example, a high performing neural network architecture may be associated with a high true-latency. Nonetheless, if a latency of a large neural network architecture is incorrectly estimated/predicted to be lower than an actual latency, a NAS process may exploit such a low latency estimate to provide an incorrect/suboptimal solution.

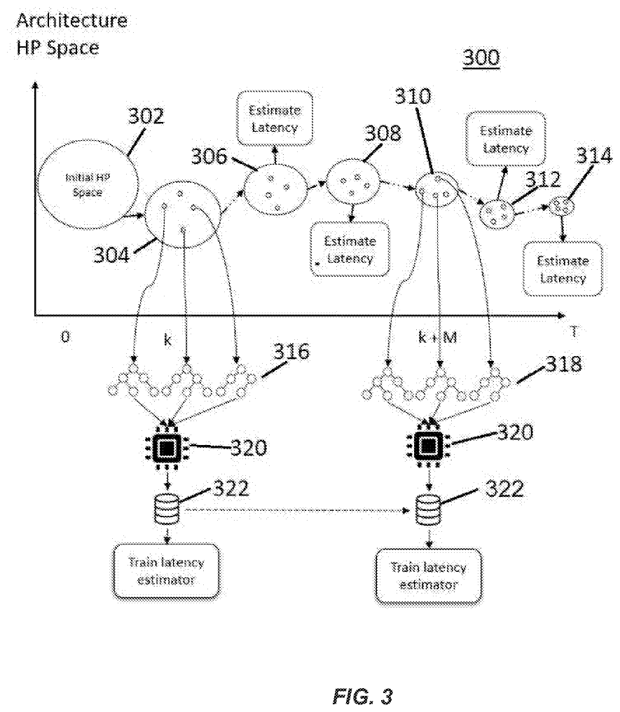

According to an embodiment, NAS process 300 shown in FIG. 3 may apply a latency estimator that is based, at least in part, on a trained computational model (e.g., neural network). During NAS process 300, a NAS algorithm may sample a concentration of HP samples (which may be a subset of a larger search space) and generate and/or select corresponding neural network architectures. Such samples of a HP search space may then be used to construct corresponding

NN architectures (e.g., at block 509, FIG. 5). Estimated latencies associated with the generated/selected architectures may be aggregated, along with other functional losses and constraints for computing a loss function (e.g., according to expression (1)), may be used by a NAS algorithm to update its state. NAS process 300 may iterate until an end condition is met. During progression of NAS process 300, at every M iterations, all or a portion of sampled neural network architectures may be executed by NPU 320 to empirically determine/measure latencies, while such latencies may also be estimated by a trained estimator. Such empirically determined/measured latencies obtained every M iterations may be first captured in buffer 322, followed by training of a latency estimator based on parameters stored in buffer 322.

In a particular implementation, a neural processing unit (NPU) 320 may execute implementations of sampled HP spaces in the execution of NAS process 300 to generate empirically determined/measured latencies. Estimates computed by a latency estimator (having parameters trained based, at least in part, on empirically determined/measured latencies) may then be applied in computing a loss function. For example, empirically determined/measured latencies for candidate architectures 316 and 318 may be computed to provide ground truth labels. A loss function may be applied to estimated latencies and empirically determined/measured latencies to update parameters of a latency estimator using backpropagation, for example. In one particular implementation, such a latency estimator may comprise a neural network with trainable weights. It should be understood, however, that other estimator/predictor models with trainable parameters may be implemented to estimate/predict latencies, and claimed subject matter is not limited in this respect. Constraining training samples to estimated latencies of candidate neural network architectures 316 and 318 selected locally from search spaces 304 and 310 may enable trained estimators to more accurately model latency behavior of neural network architectures being traversed in NAS process 300. Such a trained estimator may have improved robustness and accuracy since a concentration of HP samples may be smaller than a set of possible HP samples that an entire HP search space is capable of generating. According to an embodiment, neural network architectures selected in NAS process 300 may evolve and be applied intermittently to update a latency estimator implemented by NPU 320. Training such a latency estimator based on locally selected candidate neural network architectures may contribute to estimator robustness and efficiency.

Storing samples in buffer 320 may enable reuse of empirically determined/measured latencies and other parameters to enable continuous update of a latency estimator while NAS process 300 executes, thus reducing data-generation and development time. A locally-adapted/fine-tuned latency estimator updated via continuous training may enable the continuous adaptation to NAS process sampling states. As data is generated locally over iterations of NAS process 300, older latency estimates and empirically determined actual latencies may be purged/aged out from buffer 322. Updating a latency estimator based on locally defined neural network architectures may simplify a process of training an estimator while minimizing risks of catastrophic forgetfulness of earlier sampled architectures (which can happen due to varying reasons, such as finite or limited latency estimator capacity, training sample generating distribution shifts, etc.).

In some implementations, updating a latency estimator intermittently (e .g., every M-steps) may allow the latency estimator to deviate from a state of NAS process 300 for iterations in which the latency estimator is applied with no corresponding update to the latency estimator (e.g., based on empirically measured/determined actual latencies). This may introduce a lag in an update of a latency estimator with respect to a state of NAS process 300. According to an embodiment, lags in an update of an estimator may be at least partially overcome using a “look-ahead” technique in which stub or “dummy” neural networks may be propagated forward and sampled for updating parameters of a latency estimator.

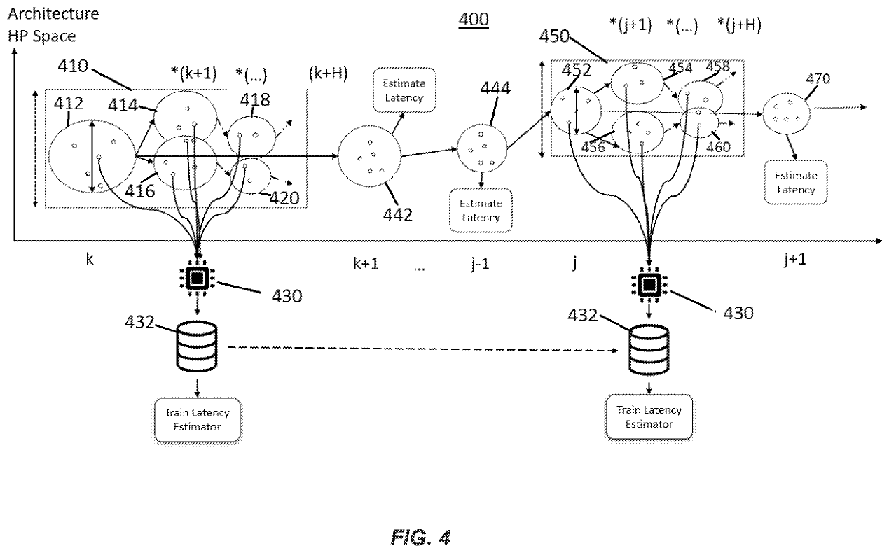

As shown in FIG. 4, according to an embodiment, a NAS process 400 may establish search spaces 412, 442, 444, 452 and 470 at iterations k, k+1, j−1, j and j+1, respectively. NAS process 400 may also establish additional dummy search spaces 414, 416, 418 and 420 following iteration k over a first look-ahead window H and dummy search spaces 454, 456, 458 and 460 following iteration j similarly over a second look-ahead window H for creating additional localized observations for use in training/updating a latency estimator. According to an embodiment, dummy search spaces 414, 416, 418 and 420 may be determined/selected to be local along a trajectory near/local to search space 412 at iteration k to search space 442 at iteration k+1. Likewise, dummy search spaces 454, 456, 458 and 460 may be determined/selected to be local along a trajectory from search space 452 at iteration j to search space 470 at iteration j+1.

As pointed out above, empirically determined/measured latencies of the architectures selected from search space 412 may be stored in buffer 432. Empirically determined/measured latencies of the architectures selected from search spaces 414, 416, 418 and 420 may be obtained from execution of the selected architectures on NPU 430 and likewise stored in buffer 432. Estimated and/or predicted latencies for architectures selected from search spaces 412, 414, 416, 418 and 420 computed from a latency estimator along with associated empirically determined/measured latencies (stored in buffer 432) as ground truth labels may be processed to update/train parameters of the latency estimator (e.g., update weights of the latency estimator by backpropagating based on a gradient applied a loss function). Computing parameters of a latency estimator to be applied at search space 442, a latency estimator updated using additional estimated and/or predicted latencies of architectures selected from search spaces 414, 416, 418 and 420 along with associated empirically determined latencies, may provide a broadened space over which the latency estimator may be trained. Selecting/determining search spaces 414, 416, 418 and 420 to be local with respect to a main trajectory to search space 442 may additionally focus training samples to be in proximity to a highly likely region over which a main trajectory to search space 442 may proceed. A latency estimator for application to search space 470 at iteration j+1 may be based on estimated and/or predicted latencies of architectures selected from search spaces 452, 454, 456, 458 and 460 along with associated empirically determined latencies (e.g., from execution of associated HP samples on NPU 430) as ground truth labels stored in buffer 432. Selecting/determining search spaces 454, 456, 458 and 460 to be along a main trajectory to search space 470 may additionally focus training samples to be in proximity to a highly likely region over which a main trajectory to search space 470 may proceed.

According to an embodiment, a size of a look-ahead window H may be a tunable parameter. Increasing sample diversity from architectures selected from the dummy search spaces may reduce a chance of inaccurate predictions in subsequent iterations of a NAS process leading up to an update of a latency estimator. Placement of dummy search spaces may enable control of quality and compute requirements of look-ahead processes to supplement sampling to train a latency estimator.

FIG. 5 is a schematic diagram of a system 500 including implementation of a NAS agent 502 according to an embodiment. In a particular implementation, a NAS agent 502 may establish candidate networks on iterations of a NAS process based, at least in part, parameters Θ and W generated from a previous iteration of the NAS process. W may define a backpropagated superset of weights updated from backpropagation (e.g., based on a gradient of a loss function W+) from which a subset w may be selected. Subset w (of superset W) may be selected to be applied at various nodes in a candidate NN while Θ may comprise an array to define selectable options for topological features of such a candidate NN.

In one particular implementation, values in array Θ may define an available number of channels for particular layers of a candidate NN (e.g., 8, 16, 32 or 64 channels for a particular layer(s)) as follows:

$$Θ = [ \begin{matrix}{θ}_{1} \\ … \\ {θ}_{n}\end{matrix} ] ,$$

where values for row vector θᵢ are weights assigned to particular available selections for a number of channels in a layer i of the candidate NN.

According to an embodiment, controller 504 may compute a preference matrix P as follows:

$$P = [ \begin{matrix}{p}_{1} \\ … \\ {p}_{n}\end{matrix} ] ,$$

where row vector pᵢ may comprise a preference ordering of a subset of NN hyperparameters (e.g., probabilities of selecting among a set of channel sizes for a layer i of a candidate NN).

In a particular implementation, values for row vector pᵢ may be computed according to expression (2) as follows:

pᵢ=softmax(θᵢFᵢ(W)), (2)

where:
Σⱼp_{i,j}=1; and
Fᵢ is a function which may or may not consider weights W in selection probability determination.

According to an embodiment, application of a softmax operation at expression (2) may convert values in θᵢ to a probability mass function. According to an embodiment, HP sampler 506 may obtain instances of a hyper-parameter s from an HP search space defined at least in part by preference matrix P. Block 506 may implement a sampling function S(P) that maps to a search space array s as follows:

$$s = [ \begin{matrix}{s}_{1} \\ … \\ {s}_{n}\end{matrix} ] \qquad ( 3 )$$

where row vector s^{k} comprises parameters defining the k^{th} sampled topology of a candidate NN such as, for example, activation functions and a number of channels at one or more layers of the candidate NN. According to an embodiment, values for a row vector s^{k} may be determined according to expression (4) as follows:

$$\begin{matrix}{s}^{k} = [ \begin{matrix}{s}_{1}^{k} \\ … \\ {s}_{n}^{k}\end{matrix} ] ∼ S ( P ) = S ( [ \begin{matrix}{p}_{1} \\ … \\ {p}_{n}\end{matrix} ] ) \\ = S ( [ \begin{matrix}[ ( {θ}_{1} , W ) ] \\ … \\ [ ( {θ}_{n} , W ) ]\end{matrix} ] ) \\ = S [ ( Θ , W ) ] ,\end{matrix} \qquad ( 4 )$$

where:
S(P) is a stochastic sampling function; and comprises a softmax operation (e.g., according to expression (2)).

According to an embodiment, element sⱼ^{k} of vector s^{k} may comprise a value indicating the j^{th} hyper-parameter selection following the k^{th} sampling, where sⱼ^{k}˜S(pᵢ) follows pᵢ selection preference ordering. In an implementation, sⱼ^{k} may be determined based, at least in part, on a probability distribution for sampling among hyper-parameters such as among channel options for a j^{th} layer of a candidate neural network. For example, for such a j^{th} layer, a channel size may be selectable from available channel sizes in set {10, 30, 60}. Here, for example, a value of sⱼ^{k}=3 may indicate selection of a third element in the set or a channel size of 60 for a j^{th} layer of candidate neural network n^{k}.

According an embodiment, a net constructor at block 509 may map weights in superset W to sampled candidate NN topologies in s to provide associated sampled candidate NNs n at block 512. According to an embodiment, block 509 may define features of actual candidate neural networks such that a candidate neural network k may be determined as n^{k}=Net (s^{k}, W). For example, function Net may apply s^{k} to determine weights w as a subset of W to be implemented in n^{k}. In a particular implementation, in an iteration of a NAS process block 509 may output a set of candidate neural networks {n^{k}} expressed as sampled pairs {<n^{k}, s^{k}>} to be applied in computing a functional loss at block 514 while a subset of sampled pairs are applied at NPU 522 for empirically determining and/or measuring latencies to be used in updating a latency estimator at block 518.

As shown, block 514 may comprise computing a functional loss component (e.g., L_{fun}(W, Θ) as shown in expression (1)) associated with an overall loss function based, at least in part, on application of training sets to sampled candidate NNs n¹, n² and n³. For example, block 514 may apply training sets as inputs to NNs n¹, n² and n³ for computing predictions to be compared to ground truth observations for computation of L_{fun}(W, Θ). Here, block 514 may apply any one of several loss functions such as, for example, a mean square error loss function.

According to an embodiment, execution latency of a candidate NN may be largely determined based, at least in part, on its associated topology (e.g., number of channels per layer and activation functions implemented at each layer) irrespective of weights applied at nodes of the candidate NN. Of NNs n¹, n² and n³, corresponding sampled topologies s¹, s² and s³ may be provided as inputs to latency estimator 518 for computation of latency estimates as inputs to a latency loss component (e.g., Lₗₐₜ(W, Θ) as shown in expression (1)). As pointed out above, parameters defining latency estimator 518 may be updated based, at least in part, on empirically determined latencies. In an embodiment, estimator update 520 may empirically measure and/or determine latencies late and lat 3 from execution of selected sampled topologies s¹ and s³ on NPU device 522 to be store in buffer 524.

According to an embodiment, block 510 may select optimal parameters Θ* and W* according to a cost-constrained dual optimization to achieve a best functional performance while satisfying a target latency constraint lat_{tgt} according to expression (5) as follows:

$${Θ}^{*} , {W}^{*} = {argmin}_{Θ , W} \{ {L}_{fun} [ argmax ( ( Θ , W ) ) , W ] \} . \qquad ( 5 )$$

$$s . t . cost ( Θ ) = {lat}_{tgt}$$

Since term “argmax( [symbol] (Θ, W))” may be non-differentiable, block 514 may assess L_{fun} [argmax( [symbol] (Θ,W)), W] according to expression (6) as follows:

$$\begin{matrix}{L}_{fun} ( Θ , W ) = {E}_{D , S ( ( Θ , W ) )} [ L ( {y}_{true} , {y}_{est}^{k} ) ] \\ = {E}_{D , {s}^{k} ∼ S ( ( Θ , W ) )} [ L ( {y}_{true} , Net ( {s}^{k} , W ) ( x ) ) ] ,\end{matrix} \qquad ( 6 )$$

where:
yₜᵣᵤₑ is a ground truth label associated with data set D; and
yₑₛₜ is an estimated and/or predicted label computed by the k^{th} candidate neural network based, at least in part, on data set {x, yₜᵣᵤₑ}∈D.

Block 516 may determine an expected latency loss for a sample s^{k} of a candidate neural network k based on target latency constraint lat_{tgt} according to expression (7) as follows:

$$\begin{matrix}{L}_{lat} ( Θ , W ) = {E}_{S ( ( Θ , W ) )} [ L ( {lat}_{tgt} , {lat}_{est} ) ] \\ = {E}_{{s}^{k} ∼ S ( ( Θ , W ) )} [ L ( {lat}_{tgt} , LE ( {s}^{k} ) ) ] ,\end{matrix} \qquad ( 7 )$$

where latₑₛₜ=LE(s) is an estimated latency computed at block 518, for example. Block 510 may then select optimal parameters Θ* and W* according to expression (8) as follows:

$${Θ}^{*} , {W}^{*} = {argmin}_{Θ , W} \{ {E}_{D , S ( ( Θ , W ) )} [ L ( {y}_{true} , {y}_{est} ) ] + λ {E}_{S ( ( Θ , W ) )} [ L ( {lat}_{tgt} , {lat}_{est} ) ] \} , \qquad ( 8 )$$

where:

lat_{tgt} is a target latency (e.g., maximum or upper bound latency); and
latₑₛₜ is an estimated latency of a candidate NN determined by block 518 based, at least in part, on a NN topology according to s^{k}.

According an embodiment, a value for Lₗₐₜ(lat_{tgt}, latₑₛₜ) may be computed at block 516 based on a cross-entropy loss (CE) according to expression (9) as follows:

$$\begin{matrix}{L}_{fun} ( {y}_{true} , {y}_{est} ) = {E}_{D , S ( ( Θ , W ) )} [ CE ( {y}_{true} , {y}_{est} ) ] \\ = \frac{- 1}{ND} {\sum }_{d = 1}^{D} {\sum }_{k = 1}^{N} ( {y}_{true}^{d} log ( {y}_{est}^{k} ) ) \\ = \frac{- 1}{ND} {\sum }_{d = 1}^{D} {\sum }_{k = 1}^{N} \\ \{ {y}_{true}^{d} {log [ Net ( {s}^{k} , W ) ( {x}^{d} ) ]}_{\vert {s}^{k} ∼ S [ ( Θ , W ) ]} \} ,\end{matrix} \qquad ( 9 )$$

where:
x is an input to a neural network (e.g., image and/or audio to be classified and/or filtered); and
Net(s^{k}, W)(x^{d}) is an application of a candidate neural network defined by s^{k}, W to process input x^{d}.
   According to an embodiment, a value for Lₗₐₜ(lat_{tgt}, latₑₛₜ) may be computed by block 516 according to expression (10) as follows:

$$\begin{matrix}{L}_{lat} ( {lat}_{tgt} , {lat}_{est} ) = MSE ( {lat}_{tgt} , {lat}_{est} ) \\ = \frac{1}{N} {\sum }_{k = 1}^{N} {( {lat}_{tgt} - {lat}_{est}^{k} )}^{2} \\ = \frac{1}{N} {\sum }_{k = 1}^{N} {( {lat}_{tgt} - {LE ( {s}^{k} )}_{\vert {s}^{k} ∼ S ( ( Θ , W ) )} )}^{2} .\end{matrix} \qquad ( 10 )$$

According to an embodiment, optimizer 510 may compute Θ⁺ and W⁺ based, at least in part, on separate gradients of a loss function L_{fun}(Θ, W) (determined at block 514) and a loss function Lₗₐₜ(Θ, W). In one implementation, a gradients of loss function L_{fun}(Θ, W) may be computed based, at least in part, on L_{fun}(yₜᵣᵤₑ, yₑₛₜ) (see expression (9)) according to expression (11) and (12) as follows:

$$\begin{matrix}{Θ}_{fun}^{+} = {∇}_{Θ} [ {L}_{fun} ( W , Θ ) ] \\ = \frac{- 1}{ND} {\sum }_{k , d} {∇}_{Θ} \\ \{ {y}_{true}^{d} {log [ Net ( {s}^{k} , W ) ( {x}^{d} ) ]}_{\vert {s}^{k} ∼ S [ ( Θ , W ) ]} \}\end{matrix} \qquad ( 11 )$$

$$\begin{matrix}{W}^{+} = {∇}_{W} [ {L}_{fun} ( W , Θ ) ] \\ = \frac{- 1}{ND} {\sum }_{k , d} {∇}_{W} \\ \{ {y}_{true}^{d} {log [ Net ( {s}^{k} , W ) ( {x}^{d} ) ]}_{\vert {s}^{k} ∼ S [ ( Θ , W ) ]} \} ,\end{matrix} \qquad ( 12 )$$

In another implementation, a gradient of loss function Lₗₐₜ(Θ, W) may be computed based, at least in part, on Lₗₐₜ(lat_{tgt}, latₑₛₜ) (see expression (10)) according to expression (13) as follows:

$$\begin{matrix}{Θ}_{lat}^{+} = {∇}_{Θ} [ {L}_{lat} ( W , Θ ) ] \\ = \frac{1}{N} \sum {∇}_{Θ} [ {( {lat}_{tgt} - {lat}_{est}^{k} )}^{2} ] \\ = \frac{1}{N} {\sum }_{k} {∇}_{Θ} \{ {[ {lat}_{tgt} - {LE ( {s}^{k} )}_{\vert {s}^{k} ∼ S [ ( Θ , W ) ]} ]}^{2} \} .\end{matrix} \qquad ( 13 )$$

In a particular implementation, block 510 may compute gradients Θ⁺ and W⁺ and update corresponding parameters at iterations of a NAS process, and solve for an updated Θ and W according to expressions (14) and (15) as follows:

Θ^{t+1}=Θ^{t}−α_{Θ}(Θ⁺_{fun}+λΘₗₐₜ⁺) (14)

W^{t+1}=W^{t}α_{W}W⁺, (15)

where:
α_{Θ} and α_{W} are learning rates.

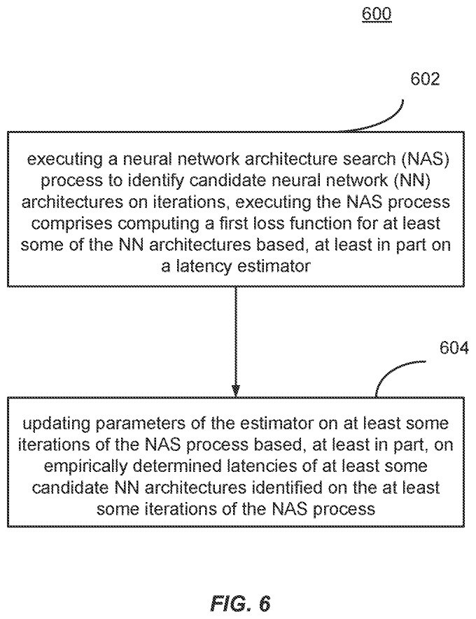

FIG. 6 is a flow diagram of a process 600 to execute a NAS, according to an embodiment. Block 602 may comprise execution of a NAS process such as a

NAS process 300 (FIG. 3) or 400 (FIG. 4). Block 602 may further comprise executing a loss function for candidate neural network architectures identified in a search space that is based, at least in part, on a latency estimator. In a particular implementation, a gradient may be applied to the loss function for use in selecting candidate neural network architectures in subsequent iterations of the NAS process. In the example shown in FIG. 5, such a gradient may be computed as shown in expression (5) and/or expression (6) while candidate neural network architectures may be selected in a subsequent iteration at blocks 506 and 509. Block 604 may comprise updating parameters of a latency estimator applied at block 602 to execute a loss function based, at least in part, on empirically determined/measured latencies of at least some candidate neural networks identified on at least some of the iterations of the executed NAS process.

According to an embodiment, a latency estimator updated at block 604

may predict and/or estimate a latency based, at least in part, on execution of a neural network with weights trained to provide an estimate and/or prediction of a latency as a part of an output tensor responsive to an input tensor that includes features of a candidate neural network architecture. It should be understood, however, that this is merely an example of how a latency estimator may be implemented, and claimed subject matter is not limited in this respect.

In this context, an “empirically determined latency” of a neural network as referred to herein means an observation/measurement of latency an actual execution of the neural network on inference hardware (e.g., one or more NPUs) to perform a particular computational task. In one example, an empirically determined latency of a candidate neural network may be obtained by application of a hardware implementation of the candidate neural network to one or more input tensors to compute one or more output tensors. In another example, an empirically determined latency of a candidate neural network may be obtained by application of a simulated/emulated implementation of the candidate neural network to one or more input tensors to compute one or more output tensors. Here, such an empirically determined latency may be obtained as an observed/measured latency to compute the output tensor. It should be understood, however, these are merely examples of how a latency of a neural network may be empirically determined, and claimed subject matter is not limited in this respect.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples;

however, again, as has always been the case with respect to the specification of a patent application, particular context of description and/or usage provides helpful guidance regarding reasonable inferences to be drawn.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public. According to an embodiment, a signal packet and/or frame may comprise all or a portion of a “message” transmitted between devices. In an implementation, a message may comprise signals and/or states expressing content to be delivered to a recipient device. For example, a message may at least in part comprise a physical signal in a transmission medium that is modulated by content that is to be stored in a non-transitory storage medium at a recipient device, and subsequently processed.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

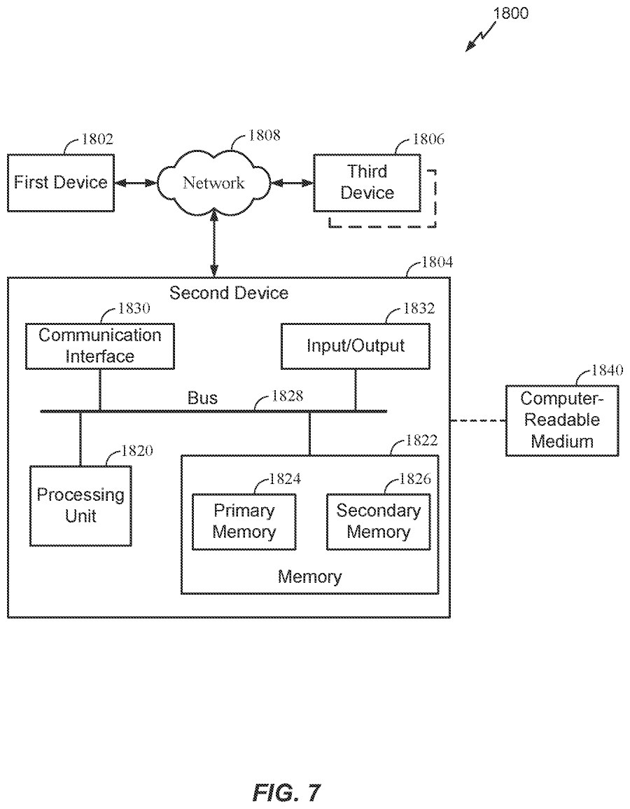

In one example embodiment, as shown in FIG. 7, a system embodiment may comprise a local network (e.g., device 1804 and medium 1840) and/or another type of network, such as a computing and/or communications network. For purposes of illustration, therefore, FIG. 7 shows an embodiment 1800 of a system that may be employed to implement either type or both types of networks. Network 1808 may comprise one or more network connections, links, processes, services, applications, and/or resources to facilitate and/or support communications, such as an exchange of communication signals, for example, between a computing device, such as 1802, and another computing device, such as 1806, which may, for example, comprise one or more client computing devices and/or one or more server computing device. By way of example, but not limitation, network 1808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 7 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 3 through 6 and in the text associated with the foregoing figure(s) of the present patent application.

Referring now to FIG. 7, in an embodiment, first and third devices 1802 and 1806 may be capable of rendering a graphical user interface (GUI) for a network device and/or a computing device, for example, so that a user-operator may engage in system use. Device 1804 may potentially serve a similar function in this illustration. Likewise, in FIG. 7, computing device 1802 (‘first device’ in figure) may interface with computing device 1804 (‘second device’ in figure), which may, for example, also comprise features of a client computing device and/or a server computing device, in an embodiment. Processor (e.g., processing device) 1820 and memory 1822, which may comprise primary memory 1824 and secondary memory 1826, may communicate by way of a communication bus 1815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1804, as depicted in FIG. 7, is merely one example, and claimed subject matter is not limited in scope to this particular example. FIG. 7 may further comprise a communication interface 1830 which may comprise circuitry and/or devices to facilitate transmission of messages between second device 1804 and first device 1802 and/or third device 1806 in a physical transmission medium over network 1808 using one or more network communication techniques identified herein, for example. In a particular implementation, communication interface 1830 may comprise a transmitter device including devices and/or circuitry to modulate a physical signal in physical transmission medium according to a particular communication format based, at least in part, on a message that is intended for receipt by one or more recipient devices. Similarly, communication interface 1830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, GNSS receiver and/or other location-identifying type capability, and/or a display with a higher degree of functionality, such as a touch-sensitive color 5D or 3D display, for example.

In FIG. 7, computing device 1802 may provide one or more sources of executable computer instructions in the form physical states and/or signals (e.g., stored in memory states), for example. Computing device 1802 may communicate with computing device 1804 by way of a network connection, such as via network 1808, for example. As previously mentioned, a connection, while physical, may not necessarily be tangible. Although computing device 1804 of FIG. 7 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1822 may comprise any non-transitory storage mechanism. Memory 1822 may comprise, for example, primary memory 1824 and secondary memory 1826, additional memory circuits, mechanisms, or combinations thereof may be used. Memory 1822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1822 may be utilized to store a program of executable computer instructions. For example, processor 1820 may fetch executable instructions from memory and proceed to execute the fetched instructions. Memory 1822 may also comprise a memory controller for accessing device readable-medium 1840 that may carry and/or make accessible digital content, which may include code, and/or instructions, for example, executable by processor 1820 and/or some other device, such as a controller, as one example, capable of executing computer instructions, for example. Under direction of processor 1820, a non-transitory memory, such as memory cells storing physical states (e.g., memory states), comprising, for example, a program of executable computer instructions, may be executed by processor 1820 and able to generate signals to be communicated via a network, for example, as previously described. Generated signals may also be stored in memory, also previously suggested.

Memory 1822 may store electronic files and/or electronic documents, such as relating to one or more users, and may also comprise a computer-readable medium that may carry and/or make accessible content, including code and/or instructions, for example, executable by processor 1820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 7, processor 1820 may comprise one or more circuits, such as digital circuits, to perform at least a portion of a computing procedure and/or process. By way of example, but not limitation, processor 1820 may comprise one or more processors, such as controllers, microprocessors, microcontrollers, application specific integrated circuits, digital signal processors (DSPs), graphics processing units (GPUs), neural network processing units (NPUs), programmable logic devices, field programmable gate arrays, the like, or any combination thereof. In various implementations and/or embodiments, processor 1820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 7 also illustrates device 1804 as including a component 1832 operable

with input/output devices, for example, so that signals and/or states may be appropriately communicated between devices, such as device 1804 and an input device and/or device 1804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
executing a neural network architecture search (NAS) process to identify candidate neural network (NN) architectures on iterations, executing the NAS process comprising computing a first loss function for at least some of the NN architectures based, at least in part on a latency estimator; and
updating parameters of the latency estimator on at least some iterations of the NAS process based, at least in part, on empirically determined latencies of at least some candidate NN architectures identified on the at least some iterations of the NAS process.

2. The method of claim 1, wherein the empirically determined latencies are determined based, at least in part, on an observed and/or measured latencies of execution of candidate NN architectures and/or simulation of candidate NN architectures.

3. The method of claim 2, wherein execution of the candidate NN architectures comprises execution of the candidate NN architectures on one or more neural processing units (NPUs).

4. The method of claim 1, wherein updating parameters of the latency estimator further comprises:
applying the latency estimator to at least some of the identified candidate NN architectures to compute predictions and/or estimates of latencies; and
applying a second loss function to the empirically determined latencies and the predictions and/or estimates of latencies.

5. The method of claim 4, wherein at least some of the parameters of the latency estimator comprise weights associated with nodes of a neural network, and further comprising:
updating at least some of the weights associated with the nodes of the neural network based, at least in part, on a gradient applied to the second loss function.

6. The method of claim 1, wherein updating the parameters of the latency estimator further comprises:
identifying a subsequent search space to define candidate NN architectures based, at least in part, on application of the latency estimator to obtain predictions and/or estimates of at least some NN architectures in a current search space;
identifying one or more dummy search spaces based, at least in part, on the subsequent search space; and
updating parameters of the latency estimator for application to at least some of the candidate NN architectures in the subsequent search space based, at least in part, on empirically determined latencies at least some NN architectures in the one or more dummy search spaces.

7. The method of claim 1, wherein the first loss function comprises a latency loss function and a functional loss.

8. The method of claim 1, and further comprising:
applying a first gradient to the first loss function for updating a super set of weights to be selectable for application of nodes of subsequently identified candidate NN architectures; and
applying a second gradient to the first loss function for updating a set of NN network topology features to be selectable for the subsequently identified candidate NN architectures.

9. The method of claim 8, wherein the set of NN network topology features comprises selectable channel sizes for at least one layer in the subsequently identified candidate NN architectures.

10. The method of claim 9, and further comprising:
mapping the selectable channel sizes to a probability mass function; and
selecting at least one of the subsequently identified candidate NN architectures based, at least in part, on the probability mass function.

11. An apparatus comprising:
one or more processors to:
execute a neural network architecture search (NAS) process to identify candidate neural network (NN) architectures on iterations, execution of the NAS process to comprise computation of a first loss function for at least some of the NN architectures based, at least in part on a latency estimator; and
update parameters of the latency estimator on at least some iterations of the NAS process based, at least in part, on empirically determined latencies of at least some candidate NN architectures identified on the at least some iterations of the NAS process.

12. The apparatus of claim 11, wherein the empirically determined latencies to be determined based, at least in part, on an observed and/or measured latencies of execution of candidate NN architectures and/or simulation of candidate NN architectures.

13. The apparatus of claim 12, wherein execution of the candidate NN architectures to comprise execution of the candidate NN architectures on one or more neural processing units (NPUs).

14. The apparatus of claim 11, wherein parameters of the latency estimator to be updated based, at least in part, on:
application of the latency estimator to at least some of the identified candidate NN architectures to compute predictions and/or estimates of latencies; and
application of a second loss function to the empirically determined latencies and the predictions and/or estimates of latencies.

15. The apparatus of claim 14, wherein at least some of the parameters of the latency estimator to comprise weights associated with nodes of a neural network, and wherein the one or more processors are further to:
update at least some of the weights associated with the nodes of the neural network based, at least in part, on a gradient applied to the second loss function.

16. An article comprising:
a non-transitory storage medium comprising computer-readable instructions stored thereon, the instructions to be executable by one or more processors of a computing device to:
execute a neural network architecture search (NAS) process to identify candidate neural network (NN) architectures on iterations, execution of the NAS process to comprise computation of a first loss function for at least some of the NN architectures based, at least in part on a latency estimator; and
update parameters of the latency estimator on at least some iterations of the NAS process based, at least in part, on empirically determined latencies of at least some candidate NN architectures identified on the at least some iterations of the NAS process.

17. The article of claim 16, wherein the instructions are further executable by the one or more processors of the computing device to:
identify a subsequent search space to define candidate NN architectures based, at least in part, on application of the latency estimator to obtain predictions and/or estimates of at least some NN architectures in a current search space;
identify one or more dummy search spaces based, at least in part, on the subsequent search space; and
update parameters of the latency estimator for application to at least some of the candidate NN architectures in the subsequent search space based, at least in part, on empirically determined latencies at least some NN architectures in the one or more dummy search spaces.

18. The article of claim 16, wherein the first loss function comprises a latency loss function and a functional loss.

19. The article of claim 16, wherein the instructions are further executable by the one or more processors of the computing device to:
apply a first gradient to the first loss function to update a super set of weights to be selectable for application of nodes of subsequently identified candidate NN architectures; and
apply a second gradient to the first loss function to update a set of NN network topology features to be selectable for the subsequently identified candidate NN architectures.

20. The article of claim 19, wherein the set of NN network topology features comprises selectable channel sizes for at least one layer in the subsequently identified candidate NN architectures.
